(19) United States
(12) Patent Application Publication
(10) Pub. No.: US 2013/0117987 A1
(43) Pub. Date: May 16, 2013

(54) System and Method for Using and Decorating a Belt Assembly

(71) Applicant: Raymond A. Rienecker, Massapequa Park, NY (US)

(72) Inventor: Raymond A. Rienecker, Massapequa Park, NY (US)

(73) Assignee: Media Planner, Inc., Remsenberg, NY (US)

(21) Appl. No.: 13/297,645

(22) Filed: Nov. 16, 2011

(51) Int. Cl. B32B 3/06; A41D 20/00; A01K 29/00; A41F 15/00; B32B 1/06; A41F 9/00; B23P 19/04

(52) U.S. Cl. 29/428; 2/338; 2/311; 2/170; 428/99; 119/856

(57) ABSTRACT

A belt assembly with perforations formed around the entire length of the belt assembly and with a fastening device that is configured to be moved with respect to selected proximate perforations to adjust the assembly. In addition, decorative clips can be to be inserted into perforations formed around the entire length of the belt assembly. Strips can also be attached to the belt assembly. The decorative clips comprise various shapes comprising stars, moons, dogs, letters, feet and hands.

### FIELD OF THE INVENTION

This invention relates generally to a belt assembly that can be passed though loops on pants, with loops located at the waistband around the pants or pants without loops and as fashion accessories for humans, pets and for connecting other objects. This invention relates more specifically to a belt assembly where a fastening device location can be adjusted between proximate perforations via a second end length adjustment assembly and/or decorated with various decorative clips and/or decorative fastening clips or combinations thereof for humans, pets and for connecting other objects.

### RELATED APPLICATION

Not applicable.

### BACKGROUND OF THE INVENTION

Individuals of all ages often have a need to wear belts around the waist of their pants or garments for necessity to secure a better fit of the pants or the garments or to use belts as fashion accessories. Often the belt does not fit well. With the belt fastener in one perforation the belt is too tight on the user, and, in another proximate perforation, the belt is too loose. There is a need to have belts with a more precise fit and also the ability to decorate the belt assembly to satisfy the consumer's varying needs.

Various prior art attempts have been developed for belt assemblies including U.S. Pat. No. 1,421,690 to Edward G. Howard that is an example of a device for use in binding or holding wearing apparel that fastens to itself with a button and perforations along the length. The band is meant to be made of an elastic type of material, specifically mentioning rubber as the material of choice. The preferred embodiment does not specify perforations going around the entire length of the band; thus, limiting adjustability of the band. In addition, the prior art does not allow for a more precise fit than just perforation spacing, removable/changeable decorations, as well as other limitations.

Another prior art device is U.S. Pat. No. 596,849 to Philibert Combier relates to a band specifically intended to hold a skirt and keep it from sagging that wraps around the waist and fastens to itself with a stud and corresponding slot. The band material is described as any suitable material, and the device is meant to provide a more efficient support of the skirt for the wearer without the hindrance of pins or buckles. The fastening mechanism is described as having studs and suitable slots. In the preferred embodiment, however, the button is not a single button but rather a pair of buttons (or noted as possibly more depending on the need for more security). In addition, U.S. Pat. No. 596,849 to Philibert Combier suffers from numerous other limitations, including those mentioned above.

Notwithstanding these prior art devices, there continues to be a need for a low cost, easily length/tension adjusted belt assembly to secure a better fit of the pants or garments, a belt that does not require integrated belt loops and can be used with fashion accessories, decorative clips, decorative fastening clips, non-decorative fastening clips and decorative hanging devices, for example.

### SUMMARY OF THE INVENTION

Accordingly, the present invention overcomes the limitations of the prior art by providing an adjustable belt assembly that can be modified with decorative clips, decorative hanging devices, decorative fastening clips, non-decorative fastening clips and the like with numerous perforations formed in the adjustable belt assembly to enable varying belt assembly fashion and length adjustment options. The belt assembly can use an optional length adjustment assembly for ease of adjusting the belt assembly fit and/or tension. The adjustable belt assembly of the present invention is such that it is simple to construct, inexpensive to make and easy to use; along with many other advantages as mentioned below.

Consequently, the present description is a simplified summary of various embodiments of the invention in order to provide a basic understanding of some aspects of the invention. This summary is not an extensive overview of the invention. It is intended to neither identify key or critical elements of the invention nor delineate the scope of the invention. Its purpose is to present some concepts/embodiments of the invention in a simplified form as a prelude to the more detailed description that is presented later.

It is another object of the present invention to provide a belt assembly that can be made of materials comprising silicone, polymers, nanotechnology materials, elastomeric microfibers, rubber, leather, fabric, stretch cotton twill, fabric elastic stretch material, nylon material, and other materials known by one of skill in the art, which can be passed through loops on pants located at a waistband, around pants, worn as a fashion accessory, worn around a waist without loops, worn by a pet, etc.

It is another object of the present invention to provide a belt assembly that can be worn as a wrist band, an ankle band, a neck band, a head band, a handbag handle, a shoulder strap, a finger ring, a toe ring, a dog collar, an animal collar, an animal harness, a band to strap objects together and the like.

It is a further object of the invention to provide a belt assembly that comprises a length adjustment assembly, a tooth engagement edge plate, and a tooth rack plate with matching grooves to enable adjustability of the belt assembly to varying lengths between proximate perforations on the belt assembly.

It is another object of the present invention to provide an adjustable turn button assembly to enable adjustment of a belt assembly within grooves on a tooth rack plate assembly.

It is yet another object of this invention to provide decorative clips, decorative fastening clips, non-decorative fastening clips and/or perforation hanging devices to be placed on a belt assembly in perforations spaced around an entire belt circumference to design the belt assembly according to a wearer's preference.

### BRIEF DESCRIPTION OF THE DRAWINGS

Embodiments of the invention will now be described with reference to the accompanying drawings.

FIG. 1 illustrates a perspective view of a belt assembly with a length adjustment assembly according to an embodiment of the invention.

FIG. 2 provides a top perspective view of a second end length adjustment assembly cover that encloses a length adjustment assembly according to another embodiment of the invention.

FIG. 3 is a top perspective view of a tooth engagement plate that mounts non-fixedly to a tooth rack plate assembly according to another embodiment of the invention.

FIG. 4 is a top perspective view of a tooth rack plate which incorporates a belt loop, a tooth rack with grooves, and a rectangular slot that can permit a fastening device assembly to slide through a rectangular slot according to another embodiment of the invention.

FIG. 5 illustrates a top perspective view of a fastening device assembly according to yet another embodiment of the invention.

FIG. 6 illustrates a top perspective view of a fastening plate according to another embodiment of the invention.

FIGS. 7-9 are cross-sectional views of a length adjustment assembly as it can be adjusted on a belt assembly according to an embodiment of the invention.

FIG. 10 illustrates a top perspective view of a fastened belt assembly according to yet another embodiment of the invention.

FIG. 11 is a side view of a decorative clip inserted in a belt assembly (the belt assembly is shown as a cross-section; the decorative clip is not illustrated in cross-section).

FIG. 12 is a top perspective view of a decorative clip that can mount to a belt assembly according to yet another embodiment of the invention.

FIG. 13 illustrates that an approximate engagement thickness of a decorative clip (t1) that is approximately equal to a thickness of a belt assembly (t2) according to an embodiment of the invention.

FIG. 14 is a side view of a decorative fastening clip inserted in a belt assembly (the belt assembly is shown as an overlapping cross-section; the decorative fastening clip is not illustrated in cross-section).

FIG. 15 is a top perspective view of a decorative fastening clip that can mount to an overlapping belt assembly according to an embodiment of the invention.

FIG. 16 shows an approximate engagement thickness of a decorative fastening clip (t4) that is approximately equal to a thickness of an overlapping belt assembly (t3) according to an embodiment of the invention.

FIGS. 17-19 show perforation hanging devices comprising different shapes according to an embodiment of the invention.

FIG. 20 is a side view of a strip with three perforations for non-fixedly attaching onto a belt assembly according to another embodiment of the invention.

FIG. 21 is a top view of a portion of a belt assembly made up of numerous strips connected together according to another embodiment of the invention.

FIG. 22 shows a side view of a portion of a belt assembly comprising star shaped decorative clips and decorative fastening clips that attach a strip mounted to the belt assembly according to another embodiment of the invention.

FIG. 23 illustrates a side view of a portion of a belt assembly wherein a strip, for example, “captures” a belt loop according to another embodiment of the invention.

FIG. 24 illustrates a functional block diagram of decorating and attaching a belt assembly according to another embodiment of the invention.

### DETAILED DESCRIPTION OF THE INVENTION

One or more implementations of the present invention will now be described with reference to the attached drawings, wherein like reference numerals are used to refer to like elements throughout. The invention relates generally to a belt assembly and more specifically to an assembly that can adjust the position of a fastening device between perforations and can be decorated with various decorative clips and/or decorative fastening clips and/or non-decorative fastening clips, perforation hanging devices, strips or combinations thereof. In addition, the belt assembly can be worn as a wrist band, an ankle band, a neck band, a head band, a handbag handle, a shoulder strap, a finger ring, a toe ring, a dog collar, an animal collar, an animal harness, a band to strap objects together and the like, known by those of skill in the art.

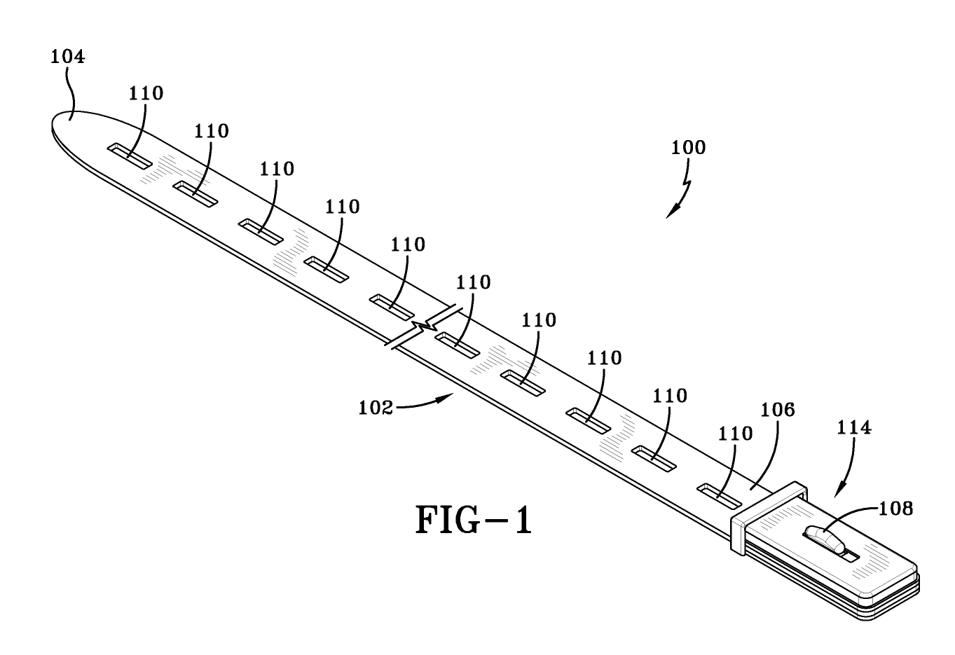

Now referring to FIG. 1, the present invention is illustrated in embodiment 100 comprising a belt assembly 102, with a first belt end 104 configured to pass through pant loops on an clothing article, for example. The first belt end 104 is shown as tapered down to a smaller width with a rounded front to ease insertion through the loops. The belt assembly 102 further comprises a second belt end 106 having a precision second end length adjustment assembly 114 configured to adjust a location of a fastening device 108 between selected proximate fastener receiving perforations 110 allowing for a more precise fit than a standard belt. The length adjustment assembly 114 further comprises the fastening device 108 to engage one of numerous fastener receiving perforations 110 which are formed in the belt assembly 102.

The fastening device 108, for example, in this embodiment 100 is a turn button configured to be rotated 90 degrees so that when non-fixedly locked the fastening device 108 is perpendicular to a long axis of the belt assembly 102. However, the fastening device 108 can comprise a button, a buckle finger, a belt buckle, a tang buckle and other fastening devices known by one of skill in the art.

The belt assembly 102 can be made of materials comprising silicone, polymers, elastomeric microfibers, rubber, leather, fabric, stretch cotton twill, fabric elastic stretch material, nylon material, nano-materials and other belt assembly materials known by one of skill in the art.

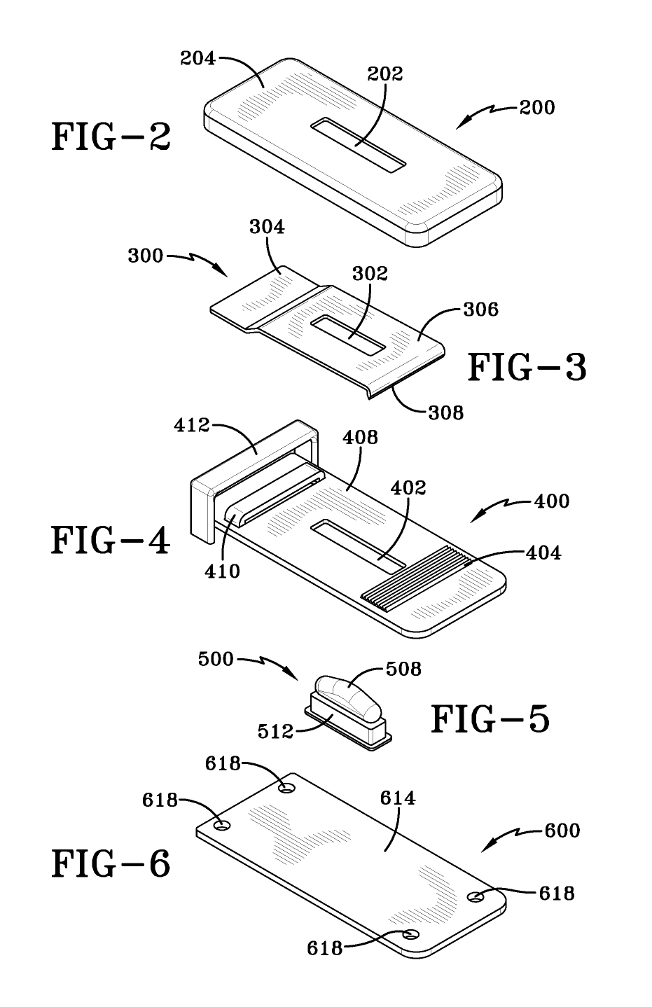

The optional second end length adjustment assembly 114 (FIG. 1) is illustrated in an “exploded type” perspective views of FIGS. 2-6 and in side cross-sectional views FIGS. 7-9. The embodiment 600 illustrated in FIG. 6 comprises a fastening plate 614 with belt fastening holes 618 configured to be attached to the second belt end 106 (FIG. 1). The fasteners can comprise rivets, screws, snaps and any other fasteners known by one of skill in the art that can be mounted through the fastening holes 618 to attach the fastening plate 614 to the belt assembly 102 (FIG. 1).

FIG. 5 illustrates a embodiment 500 of a fastening device assembly 512 comprising a fastening device 508 (in this case a turn button) wherein the fastening device assembly 512 is slideably and non-fixedly captured utilizing an elongated slot 402 in embodiment 400, for example, a tooth rack plate 408, illustrated in FIG. 4 comprising the elongated slot 402 and the fastening device assembly 512, wherein the elongated slot 402 is one of several slots allows the fastening device assembly 512 to move parallel to the long axis of the belt assembly 102 configured to adjust the location of a fastening device 108 between the selected proximate fastener receiving perforations 110. Fastening devices are well known by those of skill in the art.

A perspective view of embodiment 300 is illustrated in FIG. 3, comprising a tooth engagement plate 306 that comprises a tooth engagement edge 308, that is configured to move parallel to the long axis of the belt assembly 102 when the tooth engagement edge 308 is disengaged from one of a series of elongated grooves 404 by lifting on the fastening device 508 which in turn lifts the tooth engagement edge 308 out of the one of a series of elongated grooves 404 and the fastening device mechanism 512 is moved parallel to the long axis of the belt assembly 102. FIG. 2 illustrates embodiment 200 comprising an assembly cover 204 with an assembly cover slot 202 wherein the cover 204 encloses a portion of the fastening device assembly 512.

Referring now to embodiments 700, 800 and 900 of FIGS. 7-9, for example, the user can make a length adjustment between selected proximate perforations on the belt assembly 102. Illustrated in FIG. 7 the optional length adjustment assembly 114 is shown in a non-fixedly locked position of the embodiment 700, wherein the cover 204 is slightly bowed and the fastening device 108 (in this case a turn button) is shown rotated perpendicular to the long axis of the belt assembly 102. In the non-fixedly locked position, the tooth engagement edge 308 is spring loaded downward wherein the tooth engagement edge 308 is engaged within a first groove 722 of the series of elongated grooves 404.

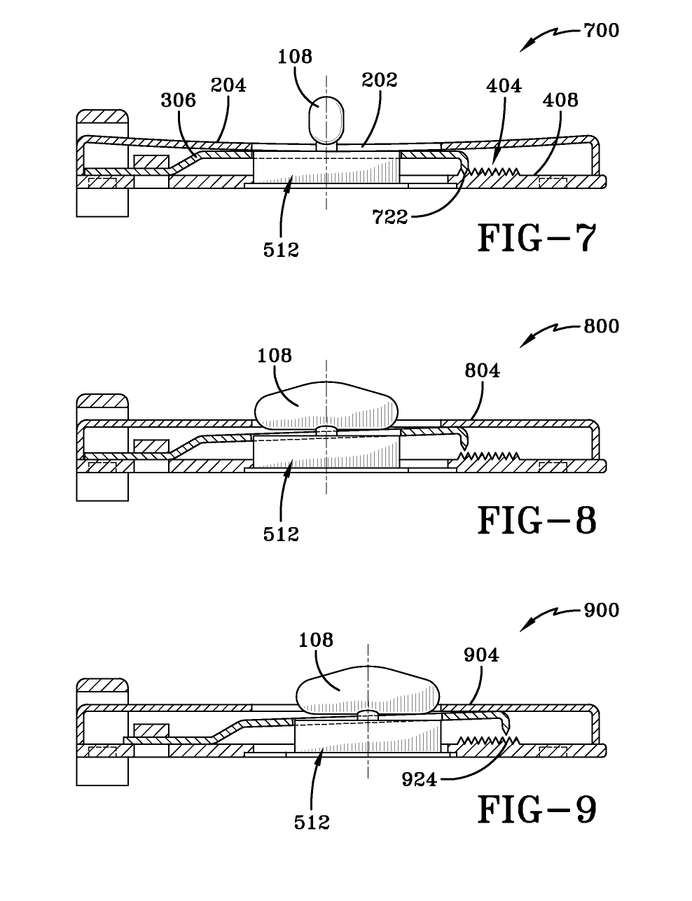

The user can adjust the position of the fastening device 108 between the selected perforations by lifting up on the fastening device 108 (in this case a turn button), turning the turn button ninety degrees overcoming a tooth engagement edge plate downward spring force as illustrated in embodiment 800 in FIG. 8 which disengages the tooth engagement edge 308 from the first groove 722 which allows the user to slide the fastening device mechanism 512 along the long axis of the belt assembly 102 within the physical constraints of the slots 202, 302 and 402. Once the user releases the fastening device 108 the tooth engagement edge plate downward force will re-engage the tooth engagement edge 308 with a second groove 924, for example as illustrated in embodiment 900 of FIG. 9. The fastening device 108 (the turn button) can be rotated by approximately 90 degrees to again non-fixedly lock the fastening device mechanism 512 in place (Note: FIG. 9 shows the fastening device 108 before it is released and therefore the tooth engagement edge 308 is not within the second groove 924). Although, the embodiments 700, 800 and 900 are illustrated as discussed above, one skilled in the art can use various other known length adjustment assemblies comprising turn screws, rack and pinions assemblies and levers, for example.

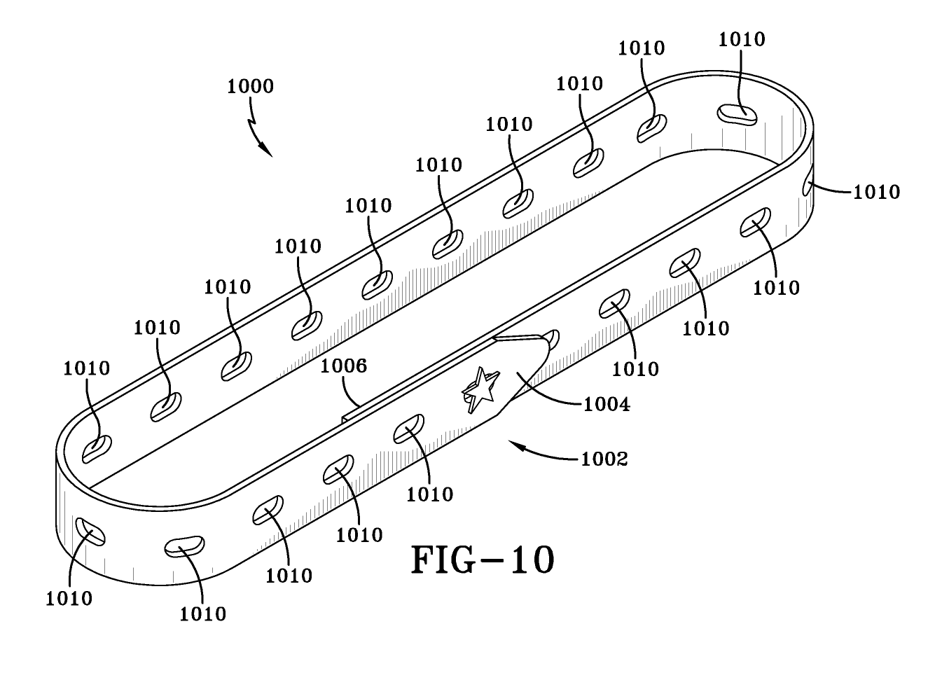

Yet another embodiment 1000 of the invention is shown in FIG. 10. FIG. 10 illustrates a fastened belt assembly 1002 comprising a first belt end 1004, a second belt end 1006 and numerous perforations 1010. The belt assembly 1002 can be passed, for example, through belt loops on a garment, wrapped around a blouse as a fashion accessory, worn over a shoulder to carry a bag, or used or worn in any other ways known by one of skill in the art. The fastened belt assembly 1002 can comprise a belt assembly, a wrist band, an ankle band, a neck band, a head band, a handbag handle, a shoulder strap, a finger ring, a toe ring, a dog collar, an animal collar, an animal harness and the like.

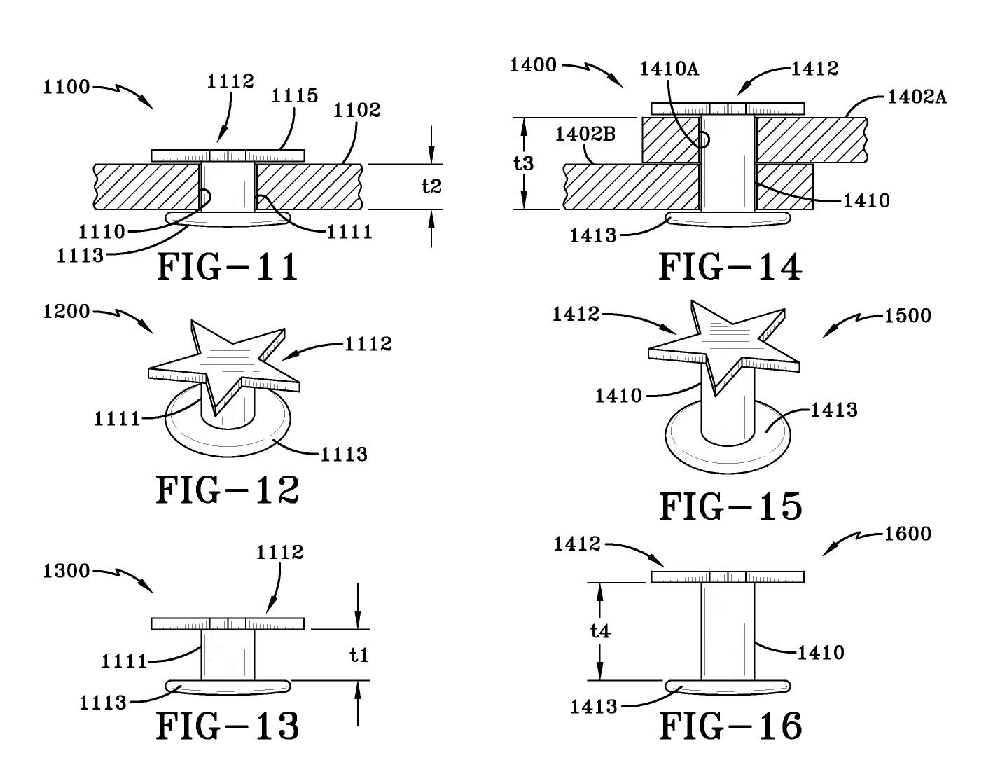

FIG. 10 illustrates the embodiment 1000 with the numerous perforations 1010 as oval shaped through holes, however, the perforations 1010 can comprise square shaped perforations, circular shaped perforations, triangular shaped perforations, star shaped perforations; or combinations thereof, and the like, as known by one of skill in the art. While the perforations 1010 in FIG. 10 are shown equally spaced around the fastened belt assembly 1002, perforations can be spaced unequally around a fastened belt assembly and in various numbers. A decorative fastening clip 1012, illustrated in FIG. 11 attaches a first perforation 1010A in the first belt end 1004 and with a second perforation (not shown) in the second belt end 1006. However, numerous numbers and shapes of decorative fastening clips can be used to connect various belt assemblies, as known by one of skill in the art.

In this embodiment 1000 of the invention, the connected belt assembly 1002 can incorporate fasteners comprising various shaped decorative clips and/or various shaped decorative fastening clips and/or non-decorative fastening clips, known by one of skill in the art. Embodiments 1100, 1200 and 1300 shown in FIGS. 11, 12 and 13 illustrate a star decorative clip 1112. FIG. 11 illustrates a side view of the star decorative clip 1112 with a portion of a belt assembly 1102 shown in cross-section with the clip 1112 through a perforation 1110. In FIG. 12 the star decorative clip 1112 is illustrated as a top perspective view and in FIG. 13 the star decorative clip 1112 is illustrated as a side perspective view

The star decorative clip 1112 has a decorative portion 1115 that is connected to an attachment button 1113 by a center section 1111. To attach the star decorative clip 1112 to the belt assembly 1102 the attachment button 1113 is “forced” slightly through the perforation 1110 in FIG. 11 distending the perforation 1110 which “springs” back to its original size surrounding the center section 1111. The star decorative clip 1112 shown in FIGS. 11-13 have a decorative clip thickness (t1, FIG. 13) that is approximately equal to a belt assembly thickness (t2, FIG. 11).

Embodiments 1400, 1500 and 1600 of a star decorative fastening clip 1412 are illustrated in FIGS. 14-16. FIG. 14 illustrates a side view of the star decorative fastening clip 1412 with two thicknesses of a cross sectional belt assembly 1402A and 1402B overlapping and fastened together with the star decorative fastening clip 1412. The star decorative fastening clip 1402 shown in FIGS. 14-16 has a clip thickness (t4, FIG. 16) that is approximately equal to two times a belt assembly thickness (t3, FIG. 14).

FIG. 14 illustrates a side view of the star decorative fastening clip 1412 with the two portions of a belt assembly 1402A and 1402B shown in cross-section with the clip 1412 through perforations 1410A and 1410B with a center section 1411. In FIG. 15 the star decorative fastening clip 1412 is illustrated as a top perspective view and in FIG. 16 the star decorative fastening clip 1412 is illustrated as a side view.

The star decorative fastening clip 1412 has a decorative portion 1415 that is connected to an attachment button 1413 by a center section 1411. To attach the star decorative clip 1412 to the belt assembly 1402 the attachment button 1413 is “forced” through the perforations 1410A and 1410B in FIG. 14 distending the perforations 1410A and 1410B which “spring” back to their original size surrounding the center section 1411. The star decorative fastening clip 1412 shown in FIGS. 14-16 has a decorative fastening clip thickness (t4, FIG. 16) that is approximately equal to two times a belt assembly thickness (t3, FIG. 14). Note: a non-decorative fastening clip is almost identical to a decorative fastening clip without a decorative portion.

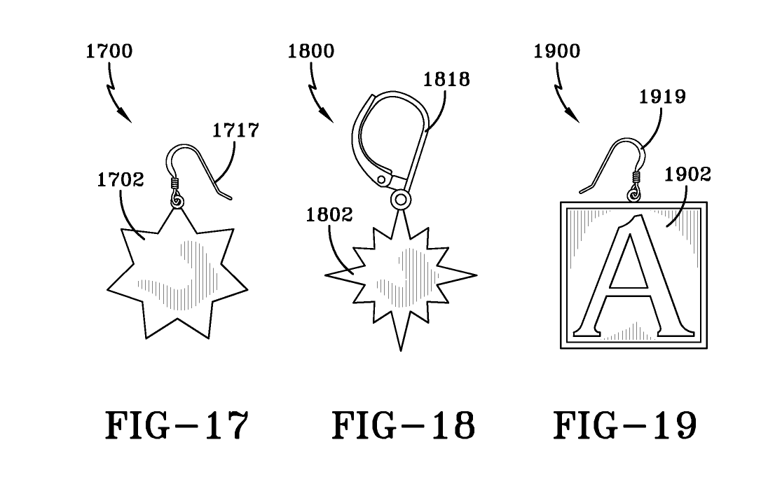

As shown in embodiments 1700, 1800 and 1900 decorative hanging devices 1702, 1802, and 1902 can comprise various shapes comprising stars 1702 (FIG. 17) and 1802 (FIG. 18), moons, dogs, cats, letters (e.g., letter A, 1902 (FIG. 19)), feet, hands, and other shapes known by those of skill in the art. Various decorative hanging devices, such as the decorative hanging devices 1702, 1802 and 1902, are for adding decorations to a belt assembly, a wrist band, an ankle band, a neck band and the like. Various decorative hanging devices can be used to add decorations to articles comprising a belt assembly, a wrist band, a book wrap, an ankle band, a neck band and the like. The decorative hanging devices can comprise metal, plastic, silicone, glass and other materials known by those of skill in the art.

The decorative hanging devices 1702, 1802 and 1902 have wire posts 1717, 1818 and 1919 respectively that can be hung on selected perforations. Locking posts (1818) and non-locking posts (1717 and 1919), hanging devices, and other hanging mechanisms are well known by those of skill in the art can be hung on selected perforations.

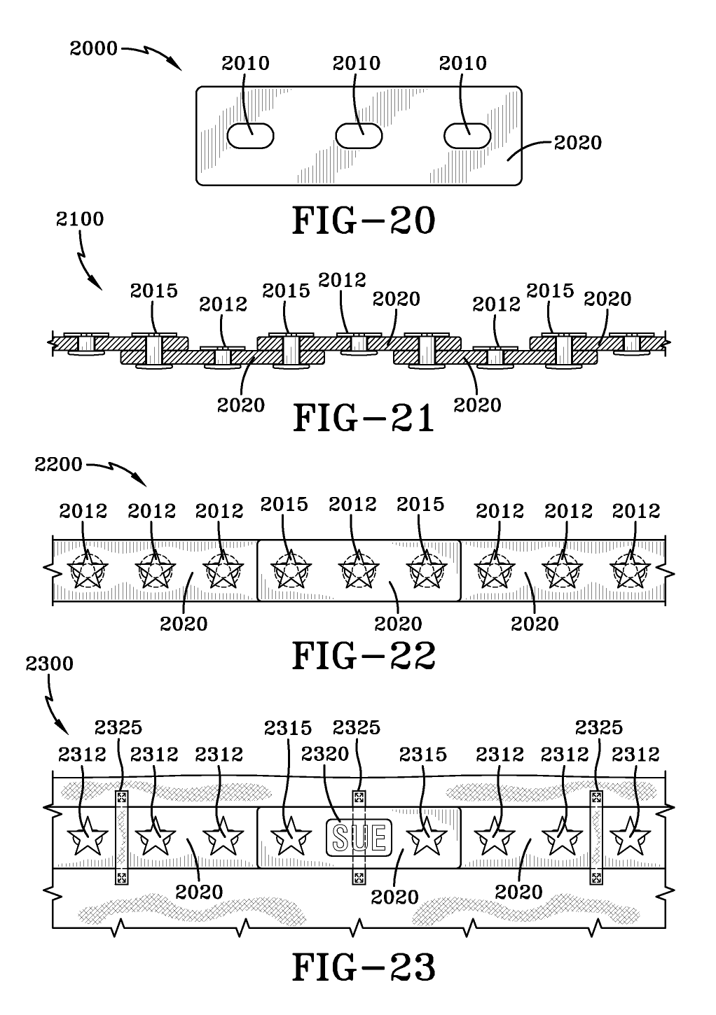

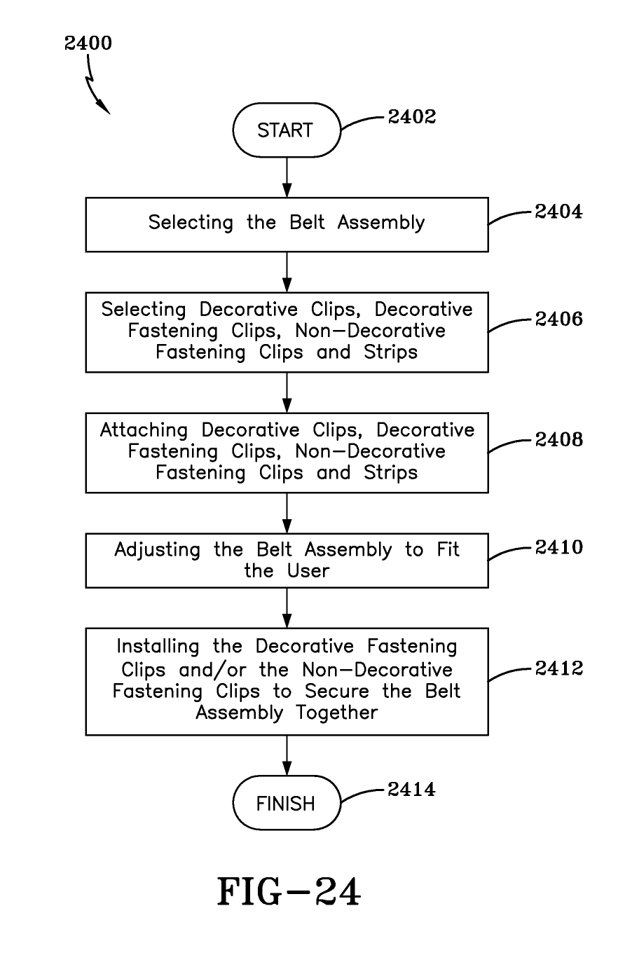

FIG. 20 illustrates yet another embodiment 2000 of the invention showing a side view of a strip 2020 with three oval shaped perforations 2010 with various uses, for example, comprising, for example: attaching a group of the strips 2020 together to form a strip belt 2101 (FIG. 21), embodiment attaching the strip 2002 to the belt assembly 2202 (FIG. 22) with the star decorative fastening clips 2015, (FIG. 20) and the like. Although the strip 2020 is shown as a length comprising three perforations 2010, strips can comprise various lengths, various shapes, various numbers of perforations, various perforation shapes, varying widths, can be embossed or decorated with shapes and patterns and the like.

In addition, in an embodiment 2300 illustrated in FIG. 23, a strip 2020 (FIG. 23) can be manufactured, for example, comprising an embossed or molded name 2320, permanently attached jewel decorations, feathers, different colors, different materials, different textures, etc. Also, the strip 2020 can be used to span a belt loop 2325 so that a belt 2302 is prevented from rotating beyond the strip 2320.

A method 2400 illustrated in FIG. 24 for assembling a belt assembly 1000 will now be described with respect to FIGS. 10-23. The method begins at 2402 with the user selecting a belt assembly 1000 at 2404. The belt assembly 1000 can comprise factors involving color, width, length, shape of perforations, thicknesses, number of perforations, materials (e.g., the materials comprise silicone, polymers, elastomeric microfibers, rubber, leather, fabric, stretch cotton twill, fabric elastic stretch material, nylon material, and the like.). These factors are well known by those of skill in the art.

At 2406 the user selects the decorative clips 1112 and/or decorative fastening clips 1412. At 2406 the user attaches a variety of the decorative clips 1202 and decorative fastening clips 1502 to the belt assembly 1000. The user can start off by inserting the decorative clips 1112 selected into one of the many perforations 1010 in FIG. 10, selected if the user wants to decorate the belt assembly 1010 with the decorative clips 1112. The decorative clips 1112 can be a single shape, or e.g., multiple shapes comprising, letters, feet, hands and other shapes known by those of skill in the art.

Continuing at 2406 the user can use the decorative fastening clips 1412 and the non-decoration fastening clips (not shown) to attach the portions of the belt assembly 1000. The user attaches the front end 1004 and the back end 1006 of the belt assembly 1000 by lining up two perforations, with the star decoration fastening clip, for example, inserted through the two perforations 1010, as illustrated in FIG. 10.

The user continues by determining if the belt assembly 1000 should have additional decorative clips 1112 added into any of the other unused perforations on the belt assembly 1000 by inserting the additional decorative clips 1112. The user continues by determining if the belt assembly 1000 should be decorated with strips 2020. If the user desires the strips 2020, they can attach the strips 2020, shown in FIG. 20 to the belt assembly 1000 with decorative fastening clips 1412, or non-decoration fastening clips (not shown), attachment devices permanently attached to the strips (not shown) or other attachment devices known by those skilled in the art. The strips 2020 can be modified to add additional decorations, or the strips 2020 can be fastened together into a belt assembly 2110 together or to lengthen the belt assembly 1000, for example.

At 2410 the user can adjust the belt assembly 1002 by various selected perforations 1010 on the first belt end 1004 and the perforations on the second belt end 1006.

At 2412 the user optionally installs additional decorative fastening clips 1502 and/or the non-decoration fastening clips (not shown) to secure the belt assembly 1002 together. The method ends at 2414.

Although the invention has been illustrated and described with respect to one or more embodiments, implementations, alterations, and/or modifications may be made to the illustrated examples without departing from the spirit and scope of the appended claims. In particular regard to the various functions performed by the above described components or structures (assemblies, devices, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including,” “includes,” “having,” “has,” “with,” or variants thereof are used in either the detailed description and the claims, such terms are intended to be inclusive in a manner similar to the term “comprising”.

What is claimed is:

1. A belt assembly, comprising:
a belt assembly with perforations formed around the entire length of the belt assembly comprising a first belt end and a second belt end wherein a second end length adjustment assembly comprises a fastening device configured to be moved and non-fixedly locked to adjust the location of the fastening device with respect to a selected perforation of selected proximate perforations to adjust a belt assembly tension; and
further comprising decorative connection clips and/or decorative fastening clips and/or non-decorative fastening clips configured to be inserted into the selected perforations formed around the entire length of the belt assembly,
further comprising strips that can be attached to the belt assembly with the decorative fastening clips and/or non-decorative fastening clips;
wherein the decorative connection clips and the decorative fastening clips comprise various shapes comprising stars, moons, dogs, letters, feet and hands;
wherein the belt assembly is made in various colors comprising red, blue, green and purple.

2. The belt assembly of claim 1, wherein
the fastening device comprises a turn button, a button, a snap, a buckle finger, a belt buckle and a tang buckle.

3. The belt assembly of claim 1, wherein the second end adjustable length assembly is made of material comprising metal, stainless steel, nano-technology materials, brass, plastics and polymers.

4. The belt assembly of claim 1, wherein the perforations comprise rectangular through holes, square through holes, circular through holes, a triangular through hole, star through holes or combinations thereof.

5. The belt assembly of claim 1, wherein the belt assembly is a material comprising silicone, polymers, elastomeric microfibers, rubber, leather, fabric, stretch cotton twill, fabric elastic stretch material, nylon material or combinations thereof.

6. The belt assembly of claim 1, wherein the belt assembly is configured to be wrapped around objects comprising human parts, animal parts and items comprising waists, packaging, fingers, necks, wrists, suspenders, ankles, pet necks, pet bodies, books, pens and blankets.

7. The belt assembly of claim 1, wherein the second end length adjustment assembly comprises a fastening plate comprising fastening holes and configured to be fixedly or non-fixedly attached to the second belt end; and
wherein an attachment assembly comprising the fastening device is configured to be slideably and non-fixedly locked by a tooth rack plate configured with an elongated slot that allows the attachment assembly to move parallel to a long axis of the non-connected belt assembly;
wherein a tooth rack plate further comprises a belt loop holding device, a tooth rack plate slot and a series of elongated teeth/grooves;
wherein a tooth engagement plate is configured to move parallel to a long axis of the belt assembly when a tapered tooth engagement plate edge is disengaged from a first groove of a series of elongated teeth/grooves by lifting on the fastening device and moving the tooth engagement plate and the non-fixedly captured attachment assembly and the fastening device;
wherein the attachment assembly is non-fixedly locked when the fastening device is released to allow the engagement of a second groove of a series of elongated teeth/grooves with the tooth engagement edge;
wherein a slotted cover is part of the second end adjustable length assembly.

8. A belt assembly, comprising:
a belt assembly comprising a first end and a second end configured to be wrapped around items comprising individual's waists, individual's fingers, individual's necks, individual's wrists, pet's necks, pet's bodies, books, pens and blankets, with fastener receiving perforations formed around the entire length of the belt assembly; and
further comprising decorative connection clips and/or decorative fastening clips and/or non-decorative fastening clips configured to be inserted into and/or hung from the perforations,
further comprising strips that can be attached to the perforations with the decorative fastening clips;
wherein the belt assembly comprises colors red, pink, black, blue, green and purple.

9. The belt assembly of claim 8, wherein the decorative connection clips have a first engagement thickness of approximately a thickness of the belt assembly; and
wherein the decorative fastening clips have a second engagement thickness of approximately two thicknesses of the belt assembly.

10. The belt assembly of claim 8, wherein the decorative connection clips and the decorative fastening clips comprise various shapes comprising stars, moons, dogs, letters, feet and hands; and
wherein the belt assembly comprises a belt loop or no belt loop;
wherein the decorative connection clips, the decorative fastening clips and the non-decorative fastening clips materials comprise metal, stainless steel, brass, plastics and polymers.

11. The belt assembly of claim 8, wherein the belt assembly that can be worn as a wrist band, an ankle band, a neck band, a head band, a handbag handle, a shoulder strap, a finger ring, a toe ring, a dog collar, an animal collar, an animal harness, a band to strap objects together, and the like

12. The belt assembly of claim 8, wherein the strips comprise various thicknesses, various lengths, various numbers of perforations;
wherein hanging device clips can be hung from the strip perforations and the belt assembly perforations comprising circular metal loops, earrings and chains.

13. A method 1300 of attaching a belt assembly by a user, the method comprising:
(a) selecting the belt assembly by the user;
(b) selecting decoration connection clips and/or fastening connection clips and/or decorative fastening connection clips and/or strips;
(c) inserting the decorative connection clips to use for decoration into perforations if the user wants to decorate the belt assembly, else (e);
(d) continuing to insert additional decorative connection clips to use for decoration into other unused perforations;
(e) overwrapping a first belt end and a second belt end so that the belt is at a selected tension;
wherein selected perforations on the first belt end and selected perforations on the second belt end are aligned;
(f) inserting a selected decorative attachment component and/or non-decorative attachment component through the aligned first belt end perforation and the second belt end perforation to non-fixedly attach the first belt end and the second belt end;
(g) ending method.

14. The method 1300 of claim 13, wherein the belt is made of material comprising elastomeric materials, leather, fabric, plastics or a combination thereof;
wherein the belt assembly is made in various colors comprising red, blue, green and purple.

15. The method 1300 of claim 13, wherein the attachment components comprise turn buttons, buttons, buckle fingers, belt buckles, tang buckles, decorative fastening clips and non-decorative fastening clip.

16. The method 1300 of claim 13, wherein the belt assembly is made of material comprising elastomeric materials, leather, fabric and plastics.

17. The method 1300 of claim 13, wherein the perforations comprise a rectangle through hole, a square through hole, a circular through hole, a triangular through hole, a star through hole or a combination therefore.

18. The method 1300 of claim 13, wherein the belt assembly is a material comprising silicone, polymers, elastomeric microfibers, rubber, leather, fabric, stretch cotton twill, fabric elastic stretch material and nylon material.

19. The method 1300 of claim 13, wherein the decorative connection clips and the decorative fastening clips comprise various shapes comprising stars, moons, dogs, letters, feet and hands.

20. The method 1300 of claim 13, wherein the non-connected belt assembly is configured to be wrapped around items comprising individual's waists, individual's fingers, individual's necks, individual's wrists, pet's necks, pet harnesses, books, pens and blankets.
